(19) United States
(12) Patent Application Publication
(10) Pub. No.: US 2011/0275443 A1
(43) Pub. Date: Nov. 10, 2011

(54) Gaming machine adjustable into multiple use configurations

(76) Inventors: Joseph W. Cole, Gallatin, TN (US); Edward H. Comfort, North Las Vegas, NV (US)

(21) Appl. No.: 12/800,048

(22) Filed: May 5, 2010

(51) Int. Cl. A63F 13/08

(52) U.S. Cl. 463/46

(57) ABSTRACT

A gaming machine has an upper housing or cabinet and a lower housing. Various gaming machine components such as a controller, wager-accepting device, and game display may be associated with the upper housing. The position of the upper housing can be changed or adjusted relative to the lower housing. Different positions of the upper housing relative to the lower housing define different configurations of the gaming machine, such as for sit-down or stand-up use.

### FIELD OF THE INVENTION

The present invention relates to gaming machines such as casino-style slot and video poker machines.

### BACKGROUND OF THE INVENTION

Gaming machines such as casino-style wagering machines come in a wide variety of configurations. Generally, casino operators offer gaming machines of different configurations in order to meet player desires. For example, some players wish to play games while seated in a standard seat. Thus, some gaming machines are configured to be played by such a seated user. These gaming machines may comprise well-known slant-type gaming machines.

Other players wish to play games in a slightly elevated position. These machines may be played by a user who is seated on a raised seat, such as a bar-stool type seat. These gaming machines may comprise various “upright” gaming machines. Yet other players may wish to play games while standing.

In addition, casino operators may locate gaming machines having these different configurations at different locations throughout their casino. The particular locations of the machines may depend upon a variety of factors, including the types of games the gaming machines are presenting, other features in the casino and the like. A casino operator might change various features in their casino. In that event, however, due to the custom-configuration of each of the gaming machines, the casino operator may then need to physically move a large number of their gaming machine to accommodate those other changes.

In order to satisfy the demand for these different gaming machines, gaming machine manufacturers build gaming machines in these various different configurations. This requires that gaming machine manufacturers custom-design and build each type of machine. Because the machines have different configurations, the manufacturer must tool different parts to construct those different machines, stock greater numbers of parts and have different assembly methods and systems (such as different assembly lines or procedures). This raises the costs associated with manufacturing the gaming machines.

When gaming machines are custom-configured, however, a number of problems arise. For example, custom-configured gaming machines tend to all have different sizes and configurations driven by the particular design or style of the machine. Because a slant style gaming machine is shorter, it may be fairly wide and deep, such as 32-36 inches deep. On other hand, a taller upright gaming machine may be only 28 inches deep. This prevents those different gaming machines from being placed side-to-side, such as in a bank of gaming machines, because of depth-alignment issues.

Also, these gaming machines may have substantially differing heights. In some instances, the height of a gaming machine may present various problems. For example, a tall upright gaming machine may be too tall to be placed in the center of a casino because its height may pose security problems (such as by blocking security camera views). This may force a casino operator to locate such machines only along outer walls of the casino.

Yet another problem arises in shipping. Some gaining machines, such as “slant-type” machines, are relatively compact. However, others such as “upright” machines can be tall and bulky. These machines are expensive to ship owing to their volume. In addition, because they are tall they are susceptible to tipping over and being damaged during shipping.

### SUMMARY OF THE INVENTION

One aspect of the invention is a gaming machine which may be adjusted into different use configurations.

In one embodiment the gaming machine comprises an upper housing or cabinet and a lower housing. The upper housing may be adjusted or moved into different positions relative to the lower housing, each position defining a different configuration for the gaming machine. In a preferred embodiment, the upper housing is configured to extend upwardly out of the lower housing.

In a first or low position the upper housing may extend out of the lower housing a first distance. This may configure the gaming machine for use by a user seated in a standard seat. In a second position the upper housing may extend out of the lower housing a second distance which is greater than the first distance. This may configure the gaming machine for use by a user seated in an elevated seat such as a bar stool. The gaming machine may be configured into a third or high position. In this position the upper housing may extend out of the lower housing a third distance which is greater than the second distance. This may configure the gaming machine for use by a user in a standing position.

In one embodiment the upper housing or cabinet has an upper portion, a middle or console portion and a lower portion. The lower portion of the upper housing moves in and out of the lower housing, thus changing the height of the upper and console portions relative to the lower housing and a floor or other support surface.

The gaming machine may include an adjustment mechanism for changing the position of the upper housing relative to the lower housing. The adjustment mechanism may comprise a lifting device such as a jack, piston or the like. In one embodiment the gaming machine may be positioned in discrete positions or configurations, such as a first, second or third position/configuration.

In a preferred embodiment, the gaming machine is provided to an operator, such as a casino operator. The gaming machine operator positions the gaming machine into the desired configuration for use. The gaming machine is then presented for use by one or more players (i.e. the gaming machine is not adjustable by the players thereof). The gaming machine may be shipped in a base or lower position to save space. The operator may then change the gaming machine into the desired operating position or configuration.

In accordance with the invention, a gaming machine may have a basic construction. However, the operator thereof may change the position of the upper housing of the gaming machine relative to the lower housing so that the gaming machine has one of at least two different possible configurations. The operator may then operate the gaming machine in that configuration and/or may change the configuration of the gaming machine in the future.

The gaming machine may have various configurations. In one embodiment the gaming machine is configured to present wagering games. In such a configuration the gaming machine may have at least one wager accepting device, one or more user input devices, a game controller configured to present a game to a player, and at least one display device configured to display game information to the player. The game controller may be located in the upper housing of the gaming machine and at least one display device may be supported by the upper housing (such as directly by the housing or by a door portion of the housing) for viewing by a player.

Further objects, features, and advantages of the present invention over the prior art will become apparent from the detailed description of the drawings which follows, when considered with the attached figures.

### DESCRIPTION OF THE DRAWINGS

FIG. 1 is a perspective view of a gaming machine in accordance with the invention in a first position corresponding to a first configuration of the gaming machine.

FIG. 2 is a perspective view of the gaming machine illustrated in FIG. 1 raised to a second position corresponding to a second configuration of the gaming machine.

FIG. 3 is perspective view of the gaming machine illustrated in FIG. 1 raised to a third position corresponding to a third configuration of the gaming machine.

FIG. 4 illustrates a gaming machine adjustment mechanism of the invention illustrated in a first position.

FIG. 5 illustrates the adjustment mechanism illustrated in FIG. 4 in a second position.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention is a gaming machine which may be adjusted or moved into different positions, each position corresponding to a different configuration for the gaming machine. A gaming machine operator may utilize the adjustment feature to operate the gaming machine in a particular configuration such as in a “sit-down” or “stand-up” configuration.

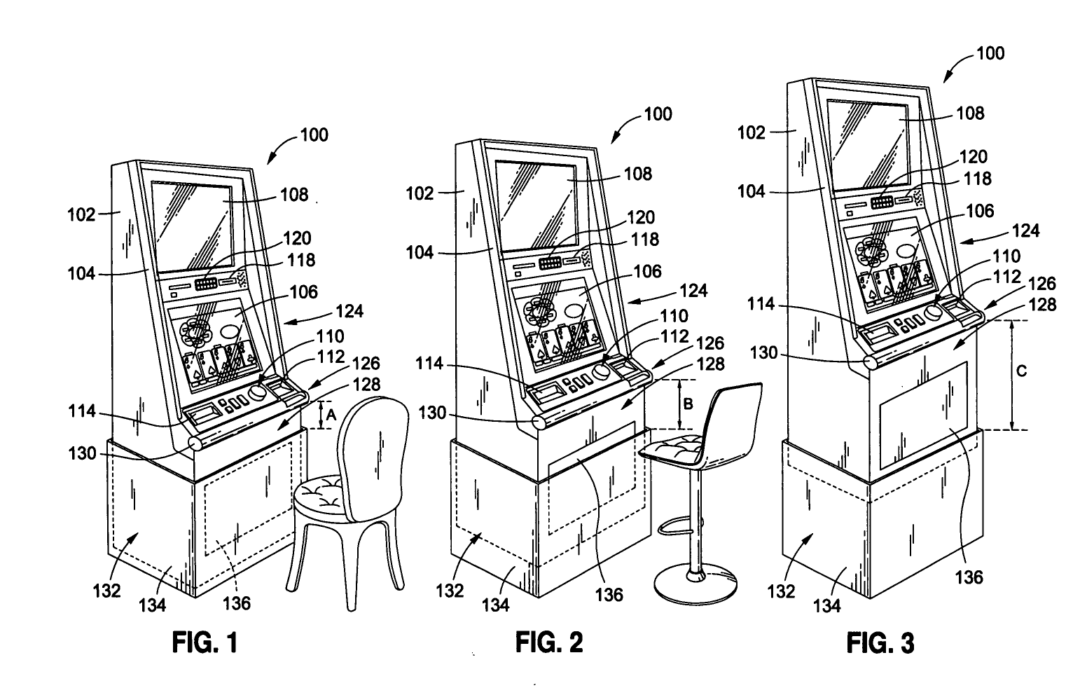

Referring to FIG. 1, in one embodiment, a gaming machine 100 defines a generally enclosed interior space for housing one or more components. As illustrated, the gaming machine 100 generally comprises an upper or first housing or cabinet 102 for supporting and/or enclosing various components required for operation of the gaming machine. In the embodiment illustrated, the upper housing 102 includes a door 104 located at a front thereof, the door 104 capable of being moved between an open position which allows access to the interior, and a closed position in which access to the interior is generally prevented.

The gaming machine 100 preferably includes at least one display device configured to display game information. In one embodiment the gaming machine 100 may include a main display 106. The main display 106 may be a mechanical, electro-mechanical or electronic display, such as one or more rotating reels, a video display or the like. When the display device 106 is an electronic video display (as illustrated), it may comprise a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 106 may be capable of projecting or displaying a wide variety of information, including images, symbols and other indicia or information associated with game play, game promotion or other events.

The gaming machine 100 may include one or more second or secondary display devices 108. Such might be associated with the upper housing or cabinet 102 with the main display device 106, or be associated with a top box or the like.

The gaming machine 100 may be configured to present a wide variety of games. In a preferred embodiment, the game or games may be of various classes (including Class II or Class III games), such as a slot game, a video poker game, a bingo or keno game, or other various other games. In one embodiment, certain game outcomes from the various possible game outcomes may be designated as winning outcomes. Prizes or awards may be provided for winning outcomes, such as monetary payments (or representations thereof, such as prize of credits), or the like. As detailed below, one or more of the awards may have certain characteristics or features.

The gaming machine 100 also preferably includes one or more player input devices 110. Such input device 110 might comprise one or more input buttons, wheels, touch-screens, joysticks, touch-pads or the like. One or more of those input device 110 may be used to accept game play input from a player. Such inputs might comprise, for example, a request to “spin” reels of a slot game, “hold” or “discard” certain cards in poker game or the like.

In a preferred configuration in which the gaming machine 100 is configured to present wagering games, included in the player input devices 110 is a means for accepting monetary value. As illustrated in FIG. 1, a bill acceptor and/or ticket reader 112 may be provided for accepting cash or paper currency and/or for accepting and reading tickets or other representations of cash or currency. It is contemplated that other mechanisms may be provided for accepting a payment, such as a coin acceptor, a credit card reader or other input devices, by which a player may directly provide funds or whereby a player may have funds paid from a remote account or source.

In one preferred embodiment, the gaming machine 100 includes at least one microprocessor or controller (not shown) for controlling the gaming machine, including receiving player input and sending output signals for controlling the various components of the machine 100 (such as generating game information for display by the display(s)). The controller may be arranged to receive input such as a purchase/bet signal when a purchase/bet button is depressed, and a value input signal when a player inserts bills, coins, a ticket, etc. The controller may be arranged to send signals for determining winning combinations to pay or credit winnings, and to cause the display to display winning amount information. In addition, the controller is preferably arranged to determine if a round of game play has resulted in a win, and if so, the prize to be awarded to the player for that win.

The controller may be configured to execute machine readable code or “software” or otherwise process information, such as obtained from a remote server. Software or other instructions may be stored on a memory or data storage device. The memory may also store other information, such as pay table information. The gaming machine 100 may also include one or more random number generators for generating random numbers for generating random game outcomes, or such might be located remotely. For example, if the gaming machine 100 is a stand-alone machine configured to present a slot game or a video poker game, the random number generator(s) might be located at the machine. However, if the gaming machine 100 is used to present server-based or networked games, such as bingo games, the random number generator(s) might be located at the server.

It will be appreciated that the gaming machine 100 may include various other electronic components. For example, the gaming machine 100 may include a bus and various peripheral drivers. The gaming machine 100 might include video controls, various lights, motors and controls (such as for spinning and stopping physical slot reels), communication interfaces and the like.

As indicated, the gaming machine 100 is particularly suited to presenting wagering games. In such a configuration, a player may initiate game play by providing value. In the case of a bingo game, this may comprise purchasing one or more bingo cards. In other types of games, this may comprise placing a wager. The purchase or wager may be made by activating one of the player input devices 110 such as a “bet one” credit button which places a single credit purchase or wager or a “bet max” credit button which places a maximum purchase or wager for that round of game play. The maximum purchase or wager is commonly defined as playing or betting an amount comprising a multiple of the value of a single purchase or wager up to a predefined upper purchase or bet limit or threshold. When the player actuates either the “bet one” credit button or the “bet max” credit button, a wager is placed or purchase is made in that amount and the player's credit base is decreased by the number of credits wagered. The player's remaining credit base is typically displayed to the player by way of the display 106.

The gaming machine 100 generally includes a means for awarding a player a prize or winnings accumulated during game play. When a player obtains a winning outcome, the player is preferably paid prizes or awards in the form of stored credits, the amount of which is indicated to the player on the display 106. A “cash out” button may be provided for permitting a player to be paid the winnings or redeeming any credits initially paid into the gaming machine 100. The term “cash out” is used herein to define an event initiated by the player wherein the player receives a number of coins or currency that is equivalent to the value of the player's accrued credit base.

Typically when a player cashes out, the gaming machine 100 is configured to dispense a media or voucher, such as via a printer 114, which represents the cash-out value. The player may utilize this voucher at other gaming machine or convert the voucher to currency, such as at a cashier's station. However, depending upon the configuration of the gaming machine 100, the player might receive a cash or coin disbursement. For example, the gaming machine 100 might be configured to activate a coin hopper or coin handling device (not shown) which physically counts and delivers the proper number of coins to the player. The coin handling device is commonly configured to transport coins from a supply source (hopper or bin filled with coins) to a coin tray or payout receptacle where the player physically receives the coins (not shown).

As indicated above, the gaming machine 100 may be configured as a stand-alone device, such as when the machine is configured to present a slot game or a video poker game. In other instances, however, the gaming machine 100 may be a server-based or networked machine. For example, the gaming machine 100 may be configured to obtain game code or game outcome information from a remote server. The gaming machine 100 may also communicate with a remote accounting server and/or player tracking server, as is well known in the art.

The gaming machine 100 may include other features. For example, as illustrated, the gaming machine 100 may include player tracking system features such as a card reader 118 and keypad 120.

The arrangement of the components of the gaming machine 100 may vary. For example, in a preferred embodiment, the displays 106,108 may be mounted to the door 104 so as to be moveable with the door. In other embodiments, the displays 106,108 might be mounted in the upper housing 102 and the door 104 may close over those displays 106,108.

In the preferred configuration of the invention, the gaming machine 100 has an upper portion or area 124, a middle or console portion/area 126, and a lower portion or area 128. In one embodiment, the displays 106,108 and various other components are located at the upper portion 124. As illustrated, these components may be arranged at one or more first orientations, such as particularly suited for viewing by a user. In one embodiment the front of the upper portion 124 of the gaming machine 100 may be defined by a top portion of the door 104. This portion of the door 104 may have a certain orientation, such as a rearward slope. The components associated with the door 104.

In a preferred embodiment, the middle portion 126 comprises a console. The console may again be defined by or be associated with the door 104. As illustrated, the middle portion 126 is located below the upper portion 124 and above the lower portion 128 of the gaming machine 100.

In one embodiment, one or more of the input devices 110, such as the player input devices (buttons or the like), may be associated with the console. The console portion 126 may have a different orientation than the upper portion 124. In one embodiment, as illustrated, the console has a reduced angle (relative to vertical) than the upper portion 124. The console portion 126 may extend outwardly, such as to a bumper 130. In one embodiment, the console portion 126 defines the forward-most portion of the gaming machine 100, with the upper and lower portions 124,128 located rearwardly/recessed back there from.

The lower portion 128 comprises a lower portion of the gaming machine 100.

In a preferred embodiment, the gaming machine 100 is adjustable into at least two different configurations. FIGS. 1-3 illustrate a gaming machine adjusted into three different configurations, as described in more detail below.

In one embodiment, the gaming machine 100 also includes a lower housing or base 132. A main portion of the gaming machine 100 defined by the upper housing 102 and the door 104 are configured to move relative to the lower housing 132. As described in more detail below, the position of at least the upper portion 124 and the console portion 126 of the gaming machine 100 may be changed relative to the lower housing 132. In a preferred embodiment, the main portion of the gaming machine 100 moves in and out of the lower housing 132.

As illustrated, the lower housing 132 comprises a bottom portion of the gaming machine 100 and is thus configured to sit or rest upon a support surface such as a floor. In a preferred embodiment, the lower housing 132 defines an enclosure. As illustrated, the lower housing 132 has one or more upwardly extending sidewalls 134. The lower housing 132 may have a closed bottom and the sidewalls 134 may extend upwardly there from, or the bottom might be open.

The number of sidewalls 134 and/or their configuration may vary, such as depending upon the configuration of the gaming machine 100. As illustrated, the lower housing 132 is generally square or rectangular, thus having four sides/sidewalls 134.

In a preferred embodiment, the main portion of the gaming machine 100, including the upper housing 102, extends out of the lower housing 132. Thus, at least a portion of a top of the lower housing 132 is open.

As described in greater detail below, an adjustment mechanism is provided for changing the position of the main portion of the gaming machine 100, or at least the upper portion 124 and the console portion 126 thereof, relative to the lower housing 132. In one embodiment, this adjustment mechanism is configured to raise and lower the upper housing 102 of the gaming machine 100.

Additional aspects of the invention will be appreciated when considering the multiple configurations of the gaming machine 100 illustrated in FIGS. 1-3.

FIG. 1 illustrates the gaming machine 100 adjusted to a first position. In this position the gaming machine 100 has a first configuration or orientation. In this first position, the upper portion 124 and the console portion 126 are in a first position relative to the lower housing 132. This may comprise a “lowered” position in which the dimension A of the bottom portion 128 of the gaming machine 100 is reduced.

As illustrated, in this position the upper portion 124 and the console portion 126 of the gaming machine 100 may be located a distance above the floor which is particularly suited for use of the gaming machine in a normal seated position. For example, when a player is seated in a normal seat (with a seat height of around 20 inches), the console portion 126 is above a user's legs and in front of the user's chest in the convenient reach of the user's arms. At the same time, the main display 106 is generally in the direct line of sight with the user's eyes. The total height of the gaming machine 100 in this first position may vary depending upon the configuration of the gaming machine (such as depending upon whether the gaming machine 100 has a top box).

In this configuration, the gaming machine 100 has a configuration similar to commonly-known “slant” type gaming machines. These gaming machines are intended to be utilized by users in a seated position and have minimal height. These gaming machines may be utilized in environments such around sports books or other locations where it is desirable for the player to be able to see over the gaming machine (such as to view television displays, odds boards or other features). Likewise, the gaming machine 100 arranged in the configuration illustrated may be utilized in such environments.

FIG. 2 illustrates the gaming machine 100 in a second position. In this position the upper portion 124 and console portion 126 of the gaming machine 100 are raised to a position higher than that illustrated in FIG. 1. As such, the height or profile of the lower portion 128 of the gaming machine 100 is increased, such as to a distance B (B>A).

In this second position, the gaming machine 100 may be particularly suited for use by a user in a second, higher or raised seated position. In particular, in this position the gaming machine 100 may be utilized by a player seated in a raised seat, such as a barstool having a seat height of about 30-36 inches. In particular, when seated in such a seat, the console portion 126 is located above the user's legs and in convenient reach of the user's arms. Likewise, the main display 106 is preferably at user eye-level. In this position the console portion 126 may be raised, and thus the total height of the gaming machine 100 may be increased.

FIG. 3 illustrates the gaming machine 100 in a third position. In this position the upper portion 124 and the console portion 126 of the gaming machine 100 are raised to a yet higher position than those illustrated in FIGS. 1 and 2. As such, the height or profile of the lower portion 128 of the gaming machine 100 is further increased, such as to a distance C (C>B).

In this third position, the gaming machine 100 may be particularly suited for use by a user in a standing position. In this position, the console portion 126 may be located at mid-torso level of the user and the main display 106 is preferably at user eye-level. In this position the console portion 126 may be raised, and thus the total height of the gaming machine 100 may be increased.

In a preferred embodiment, the main portion of the gaming machine 100 moves in and out of the lower housing 132. In order to permit the door 104 to open when the gaming machine 100 is in the first or lowest position, the bottom of the door 104 is positioned above the top of the lower housing 132, as illustrated in FIG. 1. In this configuration when the position of the gaming machine 100 is adjusted, a greater amount of the upper housing or cabinet 102 is exposed. For example, in the position illustrated in FIG. 1, a portion or distance A of the bottom of the upper housing 102 is exposed above the lower housing 132. In the position illustrated in FIG. 2, this portion increases to a portion or distance B. In the position illustrated in FIG. 3, this portion increases to a portion or distance C.

As illustrated, depending upon the position of the gaming machine 100, various components may be exposed. For example, a belly glass (which might be back-lit) or a display 136 may be located at the front of the gaming machine 100 at the lower portion 126 of the upper housing 102. When the gaming machine 100 is in its first position as illustrated in FIG. 1, this display 136 may be hidden within the lower housing 132. When the gaming machine 100 is in the position illustrated in FIG. 2, a portion of the display 136 may be revealed and thus be visible. Lastly, when the gaming machine 100 is in the position illustrated in FIG. 3, the entire display 136 may be visible.

Of course, the gaming machine 100 might include other features or have other configurations. As detailed above, the gaming machine 100 might include a top box or other known gaming machine features. Various features might be located at the lower portion 128 of the upper housing 102 of the gaming machine 100. For example, one or more storage areas might be defined in the lower portion 128 and be accessible via one or more lower doors, panels or the like.

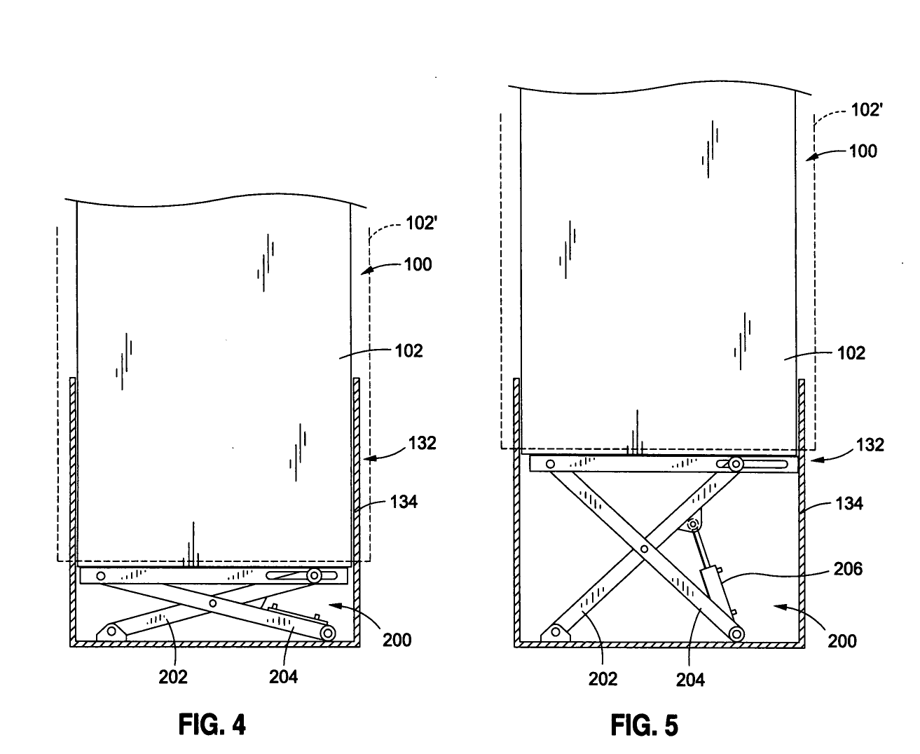

FIGS. 4 and 5 illustrate an adjustment mechanism for the gaming machine 100. In a preferred embodiment, the adjustment mechanism 100 is configured to change a vertical position of the upper housing 102 relative to the lower housing 132. The adjustment mechanism 100 may be manual or powered.

Referring to FIG. 4, a jack such as a scissor jack or lift 200 is positioned under the upper housing 102 of the gaming machine 100 and within the lower housing 132. The scissor lift 200 has first and second arms 202,204 which are movable relative to the upper housing 102 and lower housing 132. One or more means 206 may be utilized to change a position of the arms 202,204. For example, a hand crank, powered piston or other means may be used to move the arms 202,204.

As illustrated in FIG. 4, the scissor lift 200 may be arranged in a first position in which the arms are generally horizontal. In this position the scissor lift 200 has a low profile or configuration. In this position a bottom of the upper housing 102 of the gaming machine 100 is near the bottom of the lower housing 132. Such a position may correspond, for example, to that illustrated in FIG. 1.

As illustrated in FIG. 5, the scissor lift 200 may be arranged into one or more second positions where the arms 202,204 are closer towards vertical. In such a position the scissor lift 200 has a higher profile or configuration. In this position a bottom of the upper housing 102 of the gaming machine 100 is elevated, such as by being closer to a top of the lower housing 132. Such a position may correspond, for example, to that illustrated in FIG. 2 or 3.

It will be appreciated that various adjustment mechanisms may be utilized to change the position of the upper housing 102 relative to the lower housing 132. For example, the adjustment mechanism might comprise a linear jack, a hydraulic or pneumatic cylinder/piston, one or more manually-driven or powered gears that engage corresponding tracks, or other mechanisms. Preferably, each of the mechanisms permits the position of the upper housing 102 to be changed relative to the lower housing 132. In addition, the adjustment mechanism preferably comprises or further includes means for fixing the position of the gaming machine 100. For example, once the adjustment mechanism is adjusted, the position of the gaming machine 100 is preferably fixed for use (such as by locking the adjustment mechanism, by pins or the like which may be engaged to prevent undesired movement of the gaming machine 100).

FIGS. 4 and 5 better illustrate the lower housing 132. As illustrated, at least a portion of the top of the lower housing 132 is open. The upper housing 102 of the gaming machine 100 extends through the opening. In one embodiment the entire top may be open, such as where the top of the lower housing 132 is defined by the terminating side walls 134. In other embodiments, a top may extend inwardly from one or more of the side walls 134. The opening may be defined in that top.

Preferably, the opening is close in dimension to that of the upper housing 102. In this manner, the side walls 134 and/or top of the lower housing 132 are located close to the exterior/sides of the upper housing 102. This reduces the probability of objects falling between the upper housing 102 and lower housing 132, a user getting their finger or other portion of their body caught there between, and prevents access to the interior of the lower housing 132 to prevent tampering. It is possible for the lower housing 132 to include one or bellows or similar members which close the opening between the lower housing 132 and the upper housing 102, such member(s) being moveable or flexible to accommodate relative movement between the upper housing 102 and lower housing 132.

In a preferred embodiment of the invention the gaming machine 100 is moveable into pre-configured or pre-set positions, such as discrete low, middle and high position corresponding to the gaming machine configuration described above. In this manner, adjustment of the gaming machine 100 to the particular desired configuration is simplified (the casino operator, for example, does not need to try and measure or make multiple adjustments to get the gaming machine into a particular position or match the height of that machine to other machines). For example, adjustment mechanism might have particular stops or locks corresponding to designated positions (and in between those positions the adjustment mechanism might not lock, preventing the gaming machine from being maintained in another position).

As indicated above, the upper and lower housings 102,132 of the gaming machine 100 are preferably adjustable or moveable relative to one another. In the preferred embodiment, the upper housing 102 is at least partially located in the lower housing 132 and extends upwardly out of the lower housing 132. However, in other embodiments it is possible for the upper housing 102 to be located over the lower housing 132, whereby the lower housing 132 moves in and out of the upper housing 102, as in the configuration illustrated in dotted lines in FIGS. 4 and 5 (wherein the housing is designated by the reference number 102′).

Various aspects of the invention, including advantages thereof, may now be appreciated. A particular advantage of the invention is a single gaming machine which may be configured for game play in various configurations or positions. As indicated in the Background of the Invention, casinos and other game operators currently generally purchase gaming machines in various different configurations for use in various locations of their establishments. These gaming machines are custom configured and a casino must purchase gaming machines in the specific configuration which is desired. A problem which arises is that if a casino wishes to change the arrangement of the gaming machines in their establishment, they may have the wrong numbers of gaming machines in desired configurations.

In accordance with the invention, a casino can purchase a single gaming machine and configure that machine into a desired configuration. For example, a casino may purchase a gaming machine of the invention and arrange it into a standard sit-down, raised sit-down or stand-up configuration. More importantly, the casino can change the configuration of the gaming machine. For example, if a casino wishes to move the gaming machine they might wish to reconfigure it. In accordance with the invention, the casino can easily change the configuration. As one example, a casino might originally configure the gaming machine as a standard sit-down machine. After a period of time the casino might move the machine and then reconfigure the gaming machine as a stand-up machine.

Yet another advantage of the invention is the standardized sizing of the gaming machine. In accordance with the invention, a gaming machine has a standardized depth and width even though the gaming machine may be arranged into various configurations. For example, the gaming machine of the invention may have a depth of about 28 inches and a width of about 26 inches. These dimensions do not change, regardless of whether the gaming machine is configured as a sit-down/slant machine, a high seated or a stand-up machine. This means that a casino operator may place gaming machines in these variation configurations next to one another (because they all have the same depth, they align depth-wise regarding of their configuration) and it allows a casino operator to interchange machines in particular positions on the casino floor (because the machines are all of the same width, gaming machines can be swapped in a particular space without having to move adjacent machines to accommodate changes in gaming machine widths as in the prior art).

Another advantage of the invention is that the gaming machine can be configured to meet casino height requirements or other regulatory height requirements. For example, if a casino operator wishes to locate certain gaming machines near a security camera, the casino operator may configure the gaming machine of the invention into a sit-down configuration to minimize the height of the gaming machine. Such a configuration may also be utilized to meet regulatory requirements on the maximum height of a gaming machine (this permits a single gaming machine to be manufactured and shipped to various jurisdictions because the gaming machine can be configured in a manner which meets the particular requirements of any jurisdiction in which it is used, versus custom configuring gaming machines for different jurisdictions at the point of manufacture and then having to ensure that gaming machines which meet specific regulations are only shipped to and used in the compliant jurisdiction as in the prior art).

A particular advantage of the gaming machine of the invention is also that it may be shipped in a compact configuration. In particular, after manufacture each gaming machine may be configured into its first position as illustrated in FIG. 1. In this configuration the gaming machine occupies less space and thus is less costly to ship. In addition, in this configuration the height dimension of the gaming machine is minimized. This reduces the probability of the gaming machine rocking or tipping over during shipping.

For example, a casino might purchase ten (10) prior art gaming machines having a stand-up configuration. The casino might instead purchase ten (10) gaming machines of the present invention. Those gaming machines may be configured as stand-up gaming machines as illustrated in FIG. 3, but may be shipped in their reduced-profile configuration as illustrated in FIG. 1. This may save many square feet of shipping space (and generally shipping cost is dependent primarily upon space and not mass).

Another benefit of the invention is that gaming machine manufacturers can make a single gaming machine rather than multiple different gaming machines for specific purposes. This reduces the tooling costs, parts inventory costs and the like associated with having multiple gaming machines vs. a single gaming machine.

Yet another benefit is that casinos can present gaming machines in different configurations, but where the gaming machines are generally standardized. In this manner, whether a player is playing a standard sit-down or an elevated sit-down machine, the player inputs and other features of those gaming machines are the same. Because the features of the gaming machines are similar, it is easier for a player to become familiar with a gaming machine and to play that gaming machine.

The gaming machines of the invention may be used with or without a gaming machine stand. An advantage of the invention is that the gaming machines do not need to utilize a stand. Instead, the gaming machines of the invention are entirely self-contained and do not need a stand. In addition, the gaming machines of the invention have benefits over gaming machines located on stands. For example, while the height of a gaming machine may be adjusted by placing it on a stand of a different height, this simply comprises setting an already manufactured machine on one of various stands of different heights. On the other hand, in accordance with the invention an upper portion of the gaming machine is adjusted relative to a lower portion, thus changing the configuration of the machine and not merely the location of the machine.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine adjustable into different configurations comprising:
an upper housing defining an interior space;
at least one gaming machine display supported by said upper housing;
a gaming machine controller configured to cause said at least one gaming machine display to display wagering game information, said gaming machine controller located in said interior space;
a lower housing, said lower housing defining a generally closed perimeter upwardly extending wall, said lower housing having a top which is at least partially open, at least a portion of said upper housing located in said lower housing and said upper housing extending upwardly from said lower housing through said at least partially open top of said lower housing; and
an adjustment mechanism configured to change a position of said upper housing relative to said lower housing, whereby different positions of said upper housing relative to said lower housing define different gaming machine configurations.

2. The gaming machine in accordance with claim 1 wherein said adjustment mechanism permits said gaming machine to be adjusted into three discrete positions.

3. The gaming machine in accordance with claim 1 wherein said upper housing comprises a cabinet and at least one door cooperating with said cabinet to define said interior space, said door moveable between an open position and a closed position, said door in said open position permitting access to said interior space.

4. The gaming machine in accordance with claim 1 wherein said upper housing has an upper portion, a console portion and a lower portion, said console portion located between said upper and lower portions, and wherein said lower portion extends into said lower housing and whereby a position of said console portion relative to said lower housing changes in said different positions.

5. The gaming machine in accordance with claim 1 wherein said adjustment mechanism is located in said lower housing.

6. The gaming machine in accordance with claim 1 wherein said different gaming machine configurations comprise at least one sit-down use configuration and at least one stand-up use configuration.

7. The gaming machine in accordance with claim 1 wherein said adjustment mechanism is selected from the group consisting of: a scissor lift, a jack, a hydraulic piston, a pneumatic piston and a gear lift.

8. A multi-configuration gaming machine comprising:
a lower housing, said lower housing defining a generally closed perimeter upwardly extending wall, said lower housing having a top which is at least partially open;
an upper housing defining an interior space;
at least one gaming machine display supported by said upper housing;
at least one wager-accepting device associated with said upper housing;
a gaming machine controller configured to cause said at least one gaming machine display to present a wagering game in response to a wager by a player, including displaying wagering game information, said gaming machine controller located in said interior space;
said upper housing to be positioned in at least a first and a second position relative to said lower housing, wherein in each of said first and second positions at least a portion of said upper housing is located in said lower housing and wherein in said first and second positions said upper housing extends upwardly out of said at least partially open top of said lower housing by differing distances, whereby in said at least a first and second position said gaming machine has a different configuration.

9. The multi-configuration gaming machine in accordance with claim 8 wherein in said first position said upper housing extends out of said lower housing a first distance and in said second position said upper housing extends out of said lower housing a second distance, said second distance being greater than said first distance.

10. The multi-configuration gaming machine in accordance with claim 8 wherein said upper housing is configured to be positioned in one of a first position, a second position or a third position.

11. The multi-configuration gaming machine in accordance with claim 8 further comprising means for mounting said upper housing relative to said lower housing in said at least one first and second position.

12. A method of configuring a gaming machine for use comprising the steps of
providing a gaming machine comprising:
an upper housing defining an interior space;
at least one gaming machine display supported by said upper housing;
a gaming machine controller configured to cause said at least one gaming machine display to display wagering game information, said gaming machine controller located in said interior space;
a lower housing, said lower housing defining a generally closed perimeter upwardly extending wall, said lower housing having a top which is at least partially open, at least a portion of said upper housing located in said lower housing and said upper housing located in a first position relative to said lower housing for transport of said gaming machine, said upper housing extending upwardly from said lower housing through said at least partially open top of said lower housing; and
an adjustment mechanism configured to change a position of said upper housing relative to said lower housing;
utilizing said adjustment mechanism to move said upper housing to a second position relative to said lower housing to configure said gaming machine into a configuration for use of said gaming machine; and
presenting said gaming machine for play by a player.

13. The method in accordance with claim 12 wherein said second position comprises at least one of two or more use positions.

14. The method in accordance with claim 13 wherein said adjustment mechanism permits said upper housing to be positioned in no more than three particular positions including said first position and said second position.

15. The method in accordance with claim 12 wherein said adjustment mechanism is located in said lower housing and is accessible only by an operator of said gaming machine.

16. The method in accordance with claim 12 wherein said upper housing extends out of said lower housing a greater distance in said second position than said first position.
